(19) United States
(12) Patent Application Publication
(10) Pub. No.: US 2005/0161290 A1
(43) Pub. Date: Jul. 28, 2005

(54) Disc brake with electrical wear sensor and carrier for the sensor connector

(75) Inventors: Giuseppe Donadoni, Dalmine (IT); Antonio Gotti, Almenno San Salvatore (IT)

Correspondence Address: SOFER & HAROUN LLP., 317 MADISON AVENUE, SUITE 910, NEW YORK, NY, 10017, US

(73) Assignee: Freni Brembo S.p.A., Bergamo (IT)

(21) Appl. No.: 10/508,177

(22) PCT Filed: Mar. 21, 2002
(86) PCT No.: PCT/IT02/00179

(51) Int. Cl. F16D 66/00

(52) U.S. Cl. 188/1.11 L

(57) ABSTRACT

Disk brake comprising an electrical wear sensor with an electrical connector (17′), a caliper (10) having an opening (8) and at least one pin (13) fixed to the caliper between two opposite sides of the opening and means for fixing the connector (17′) to the caliper (10). To avoid special processing operations of the caliper body and to provide an easy and rapid assembly of the connector, the fixing means comprise a carrier element (20) made of shaped sheet metal that has a first part (21, 26) to which the connector (17′) is fixed and a second part (23-25) that engages with the pin (13) and the edges of the opening (8) to provide a firm attachment of the carrier element (20) to the caliper (10).

The present invention concerns disk brakes and, more particularly, a disk brake having an electric wear sensor with electric connector, as defined in the preamble of Claim 1.

It is a well known and common practice to provide brakes, irrespective of whether they are of the disk or drum type, with devices capable of detecting the state of wear of the brake linings and generally known as wear detectors These devices differ both on account of the underlying operating principle and their constructional configuration: in the case of disk brakes for motor vehicles it is a common practice to employ electric wear detectors that use a sensor associated with one of the pads of the brake caliper. These indicators transmit the signal that arrives from the sensor and indicates the wear of the pad via an electric cable that terminates at a connector, said connector being in its turn connected via another cable to a display device arranged, for example, on the instrument panel of the vehicle. The connector is generally fixed to the disk brake caliper by means of one or more screws. The caliper is shaped in such a way as to provide a seating for the connector and a faceplate with one or more threaded holes for the fixing screw or screws. This implies that the caliper has to be produced for being used together with a particular connector, and it is not therefore possible to apply to it any other connector than the one for which it is designed. Furthermore, the formation of the seating and the faceplate with the threaded hole call for specific processing operations and therefore cause additional costs. Lastly, assembly is relatively laborious.

The present invention therefore sets out to make available a disk brake with an electric wear sensor in which the fixing of the electric connector to the brake caliper does not call for special processing operations of the caliper and can be achieved easily and rapidly.

According to the invention this objective is attained by realizing the disk brake defined and characterized in general terms in the first claim.

The invention will be more clearly understood from the detailed description given below of a particular embodiment thereof, which is to be regarded as an example and not limitative in any way, said description making reference to the drawings attached hereto, of which:

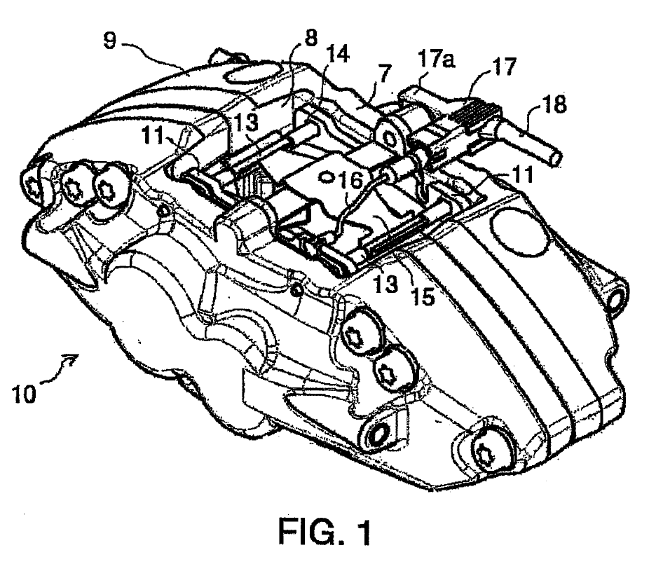

FIG. 1 shows a partial perspective view of a known disk brake with an electric connector fixed to the caliper,

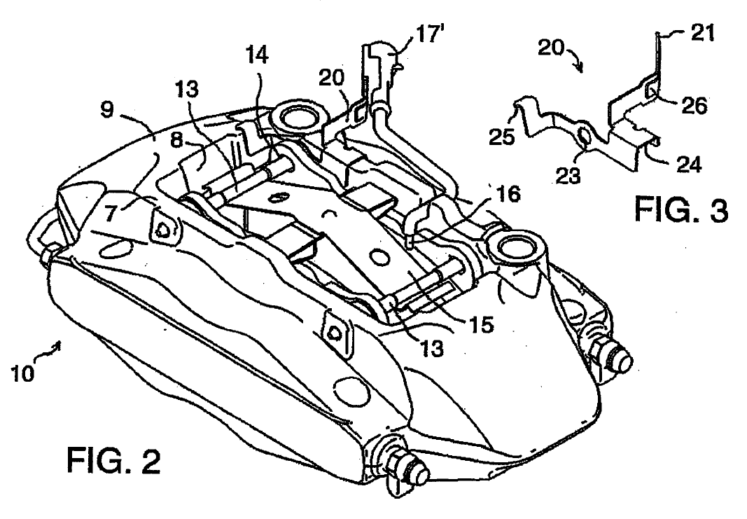

FIG. 2 shows a partial perspective view of a disk brake in accordance with the invention,

FIG. 3 shows a perspective view of a shaped sheet metal part that constitutes the carrier element of the electric connector of a disk brake in accordance with the present invention.

FIG. 1 illustrates the caliper 10 of a disk brake of the known type comprising a supporting stirrup not shown in the drawing, and a floating caliper body 9 having a rectangular opening 8. Two pads 11 provided with brake linings (not shown in the drawing) are housed in appropriate seatings of the supporting stirrup and are bound to the caliper body 9 by means of two pins 13 that pass through the holes 14 in the pads. A flat spring 15 mounted between the pins 13 exerts an elastic action on the pads 11 and maintains them in their seatings. The pins 13 extend between the two longer sides of the opening, have their ends inserted in holes that pass through two ribs 7 formed along the longer sides of the opening and are bound axially to the caliper by means of appropriate fixing devices, for example, by means of elastic expansion elements inside the holes. Other types of known calipers have only a single pin that supports and compresses a flat spring, said spring—in its turn—keeping the pads in their seatings by means of appropriately shaped arms.

An electric wear sensor, which could be, for example, an electric contact incorporated in one of the pads, has as its output terminal an electric cable 16 that at its free end carries a plug-in element, which cannot be seen in the drawing because it is inserted in a corresponding seating of the connector 17. The body of said connector, made of insulating material, is fixed to the caliper and from it there extends another electrical cable 18 intended to transmit the sensor signal to a display instrument or some other user device. For the purposes of fixing the electric connector 17, the caliper has a faceplate with a threaded hole and the electric connector 17 has an appendix 17a with a through hole; the fixing is assured by a screw, not shown on the drawing, that is inserted in the through hole and screwed into threaded hole of the caliper body. As can be seen, the caliper ham to be shaped and predisposed for the use of an electric connector of specific dimensions and a special shape and therefore call for special processing operations.

Let us now consider FIG. 2, where elements identical or equivalent to those of FIG. 1 are indicated by the same reference number. It should be noted, first of all, that the caliper body 9 does not have any threaded holes or specially processed parts for fixing the connector. The connector, here indicated by the reference number 17′, is fixed to the caliper body 9 by means of a carrier element 20 constituted by a simple piece of shaped and bent sheet metal. In particular, as can be clearly seen from FIG. 3, the carrier element 20 has a part for fixing the electrical connector 17′, in this particular example in the form of a plate 21, which can be slipped into a corresponding aperture of the connector 17′, so that the connector becomes attached to it. In the example here illustrated the plate 21 is provided with a small tab 26 that assures a snap attachment. The carrier element 20 has a second part that engages with one of the pins 13 and with the edges of the opening 8 of the caliper. In the illustrated example, in particular, this second part is provided with a hole 23, is bent at a right angle in such a way as to extend along two adjacent sides of the caliper opening and shaped in such a way as to have a stirrup 24 and an end 25 bent in the manner of an L.

The carrier element 20 can be fixed to the caliper by bringing it into the position shown in FIG. 2 prior to the insertion of the pin, that is to say, with the stirrup 24 astride the rib 7 and the end bent, in the manner of an L resting on the step formed by the edge of one of the short sides of the opening, and then slipping the pin through the hole 23 and into the hole provided in the rib 7 along the opening. As can readily be seen, the carrier element 20 thus remains firmly fixed to the caliper without there being need for any other fixing device.

One can also readily note the advantages of the invention as compared with the prior art: the fixing of the electrical connector of the sensor does not call for the provision of any specific structural elements of the caliper body or any special processing thereof, but use is rather made of elements that are already present in a customary disk brake, namely the pin carrying the pads and the edge of the opening of the caliper. The only additive part is a piece that is as easy to produce as the holed and bent sheet-metal piece 20. Furthermore, any disk brake of the type defined at the beginning of this description can be transformed into a disk brake in accordance with the invention without there being need for any special intervention other than preparing a holed and bent sheet-metal piece 20 that fits the dimensions of the opening and the pin. Any type of connector can be used without having to do anything other than providing suitable means for fixing the connector to the carrier element. Lastly, assembly of the components is extremely easy and rapid.

1. A disk brake comprising:
an electrical wear sensor with an electrical connector;
a caliper having an opening and at least one pin fixed to the caliper between two opposite sides of the opening; and
means for fixing the connector to the caliper, wherein said fixing means comprise a carrier element made of shaped sheet metal that has a first part to which the connector is fixed and a second part that engages with the pin and the edges of the opening to provide a firm attachment of the carrier element to the caliper.

2. A disk brake in accordance with claim 1, wherein the second part of the carrier element has a hole to provide a passage for the pin.

3. A disk brake in accordance with claim 2, wherein the second part of the carrier element is bent at a right angle and extends along two adjacent sides of the opening of the caliper.

4. A disk brake in accordance with claim 3, wherein the caliper is provided with a rib along at least one side of the opening and wherein the second part of the carrier element is shaped in such a way as to have a stirrup that embraces said rib.

5. A disk brake in accordance with claim 3, wherein the second part of the carrier element has an end bent in the manner of an L that rests on an edge of the opening.

6. A disk brake in accordance with any one of the preceding claims, wherein the first part of the carrier element and the connector has complementary snap-type engagement elements.

7. A disk brake in accordance with claim 6, wherein the complementary snap-type engagement means has a tab provided on the sheet-metal carrier element.
